(19) United States
(12) Patent Application Publication
(10) Pub. No.: US 2004/0266432 A1
(43) Pub. Date: Dec. 30, 2004

(54) Method for providing information on the reconnectability of a subscriber in a mobile radiotelephone network, disconnected from another subscriber during a telephone call

(76) Inventor: Michael Zwach, Modling (AT)

Correspondence Address: BELL, BOYD & LLOYD, LLC, P. O. BOX 1135, CHICAGO, IL, 60690-1135, US

(21) Appl. No.: 10/490,982

(22) PCT Filed: Sep. 10, 2002
(86) PCT No.: PCT/EP02/10142

(30) Foreign Application Priority Data
Sep. 28, 2001 (EP) 01123441.6

(51) Int. Cl. H04Q 7/20

(52) U.S. Cl. 455/435.1; 455/423; 455/433

(57) ABSTRACT

The invention relates to a method for providing information to a first subscriber, in a mobile radiotelephone network, on the reentry of a second subscriber in the transmission/reception area of said mobile radiotelephone network, disconnected after leaving the transmission/reception area of the mobile radiotelephone network during a telephone call between both subscribers, whereby said mobile radiotelephone network transmits a message to the first subscriber, when the second subscriber is again reachable.

### BACKGROUND OF THE INVENTION

The present invention relates to a method for notifying a first subscriber in a mobile network about the reentry into the mobile network's transmission/reception area of a second subscriber disconnected owing to having left the mobile network's reception/transmission area while a call was in progress between both subscribers, with each subscriber being assigned a mobile radio device each having at least one telephone number in the mobile network.

The present invention further relates to a telecommunication system with a mobile network and at least two mobile radio devices to each of which at least one telephone number is assigned in the mobile network.

When call connections have been established between subscribers in a mobile network, there may be undesired connection drops due to one of the call partner's having left the mobile network's transmission/reception area.

Such situations can arise, for example, on railroad links, during the traversing of a tunnel, or in areas with low or, as the case may be, poor radio coverage such as in mountainous regions, for instance.

There is as yet no known possibility of automatically notifying the other call participant, usually still located within the mobile network's transmission/reception area, about the restored accessibility of the subscriber temporarily unable to transmit/receive upon the subscriber's reentry into the mobile network's transmission/reception area. As is generally known, the re-accessible subscriber can only notify his/her call partner that he/she is accessible again by calling the partner again.

As soon as the subscriber who left the network has “reception” again, his/her mobile radio device will, in the case of known GSM networks, log onto the network again. The new status will then be entered in a Home Location Registry (HLR).

The HLR register is a component of the switching subsystem in GSM networks. The HLR database is the central database within the GSM architecture. Stored in the database is all the information about the mobile subscribers who are to be assigned to a specific stationary area. This subscriber data serves, among other things, to set up connections and to manage services. There also may be a number of HLR registers in a GSM network depending on its size, the number of subscribers, and the network organization. An HLR register customarily can administer hundreds of thousands of subscribers, with the subscriber's telephone number being able to display to which GSM network the subscriber belongs and in which Home Location Register his/her data is located.

Although leaving the network and reentering the network's reception area is recognized by the Home Location Registry in the case of GSM networks, reentering of the mobile network's transmission/reception area frequently is not registered by the disconnected call partner because the mobile radio device of the subscriber leaving the mobile network's area is customarily not permanently monitored by the subscriber in order to check network reception.

The call partner still located within the network's transmission/reception area usually will give up re-accessing the other subscriber after a few unsuccessful attempts. It may consequently happen that a reentry into the network's transmission/reception area will not be noticed by either call participant for a long period of time. This can bring major disadvantages in terms of usage convenience.

An object of the present invention is, therefore, to provide a way to enabling the other subscriber to be notified in a simple and cost-effective manner in the event of an undesired drop of a call in progress in a mobile network due to a call participant's having left said network's transmission/reception area upon the participant's reentering the network's transmission/reception area.

### SUMMARY OF THE INVENTION

Such object is achieved according to the present invention by a method of the type mentioned at the beginning whereby the telephone number of the first subscriber's mobile radio device is stored by the mobile network when the second subscriber's mobile radio device leaves the mobile network's transmission/reception area and is used to convey a message concerning the reentry of the second subscriber's mobile radio device into the mobile network to the first subscriber's mobile radio device when the second subscriber's mobile radio device reenters the mobile network's transmission/reception area.

An advantage of the present invention is that a call partner remaining in the network's transmission/reception area can be notified immediately when the other call partner is accessible again.

In a preferred embodiment of the present invention, the telephone number of the first subscriber's mobile radio device is stored in a subscriber administration facility of the mobile network.

The mobile network is advantageously a GSM network or a UMTS network wherein the subscriber administration facility can be a Home Location Registry.

Particularly suitable for implementing the method according to the present invention is a telecommunication system of the type mentioned at the beginning which has been set up for storing the first mobile radio device's telephone number when a second subscriber's mobile radio device leaves the mobile network's transmission/reception area while a call is in progress with a first mobile radio device, and for conveying a message concerning the reentry of the second subscriber's mobile radio device into the mobile network to the first subscriber's mobile radio device when the second subscriber's mobile radio device reenters the mobile network's transmission/reception area.

A subscriber administration facility is advantageously provided for the mobile network, the facility having been set up for storing the first mobile radio device's telephone number.

A provision of a particularly advantageous embodiment of the present invention is that the mobile network is a GSM network or UMTS network wherein the subscriber administration facility can be a Home Location Registry.

Additional features and advantages of the present invention are described in, and will be apparent from, the following Detailed Description of the Invention and the Figures.

### BRIEF DESCRIPTION OF THE FIGURES

FIG. 1 is a schematic of a telecommunication system according to the present invention with two mobile radio devices.

FIG. 2 is a schematic of a call connection between the mobile radio devices from FIG. 1.

FIG. 3 is a schematic of a drop in the call connection between the mobile radio devices from FIG. 2.

FIG. 4 is a schematic of conveying a message notifying a call partner's re-accessibility.

### DETAILED DESCRIPTION OF THE INVENTION

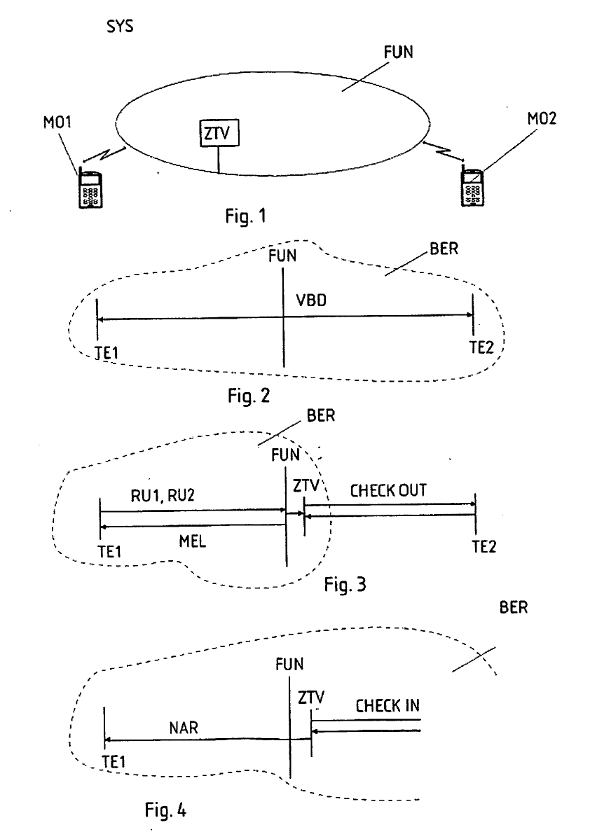

According to FIG. 1, a telecommunication system SYS according to the present invention has a mobile network FUN, such as a GSM or UMTS network, as well as at least two mobile radio devices MO1, MO2, and a subscriber administration facility ZTV. If the mobile network is a GSM or, as the case may be, UMTS network, the subscriber administration facility ZTV can be embodied as a “Home Location Registry” representing the home file for the subscribers in the mobile network FUN.

The database referred to as the home file serves to store all the information of significance to each mobile subscriber (quasi-permanent, statistical data) such as, for example, telephone number, MS identity number, device type, basic and supplementary services subscribed to, access priorities, and authentication keys. What is termed temporary (dynamic) subscriber data (for example, the mobile station's current location) that is necessary is also stored. The temporarily stored data will immediately be updated in the Home Location Registry if the subscriber leaves his/her current location area. The home file is usually kept in a mobile switching center. Each mobile subscriber and that subscriber's data is registered in precisely one home file, in which call detail recording and administration functions are also carried out.

If the two mobile radio devices MO1, MO2 are located within the transmission/reception area of mobile network FUN then, as is known, a call connection VBD can be set up between the two mobile radio devices MO1, MO2 (FIG. 2). The telephone numbers of the two mobile radio devices MO1, MO2 can be temporarily stored in a switching center involved in the current connection setup.

If one of the two mobile radio devices then leaves the network's transmission/reception area, this will be registered by the mobile network FUN and an appropriate entry made in the subscriber administration facility ZTV or, as the case may be, the Home Location Registry (FIG. 3).

In the event of a connection drop due to leaving of the network's transmission/reception area BER, the switching center that was involved in the connection setup between the two mobile radio devices MO1, MO2 can be notified by the subscriber administration facility ZTV that one of the two mobile radio devices has left the network's transmission/reception area BER. The switching center thereupon can convey the telephone number RU1 of the mobile radio device MO1 remaining in the network to the subscriber administration facility ZTV.

Another possibility would be, for example, for the switching center, following a connection drop, to transmit the telephone numbers RU1, RU2 of both telecommunication terminals to the subscriber administration facility ZTV, which will check whether one of the two mobile radio devices has left the network's transmission/reception area.

In the subscriber administration facility ZTV or, as the case may be, the Home Location Registry, the telephone number RU1 of the mobile radio device MO1 remaining in the transmission/reception area BER of the mobile network FUN then can be filed in a storage area assigned to the second mobile radio device. As well as the telephone number RU1, it is, of course, also possible to file an entry in the storage area indicating the event (the second mobile radio device's reentry into the network) which will trigger delivery of the message.

In the event of a connection drop due to a mobile radio device's MO2 having left the transmission/reception area BER while a call VBD was in progress, the telephone number RU1 of the other mobile radio device MO1 involved in the current call connection VBD can, in the above described manner, be stored by the mobile network FUN; for example, by the central subscriber administration facility ZTV or, as the case may be, the Home Location Registry.

Upon its reentry into the transmission/reception area BER, the second mobile radio device MO2 can, in the manner familiar from GSM networks, for example, be registered by the network, which is to say by the Home Location Registry or, as the case may be, by the central subscriber administration facility ZTV, with the possibility of making an appropriate entry in the storage area of the second mobile radio device MO2 in the subscriber administration facility ZTV.

According to FIG. 4, the subscriber administration facility ZTV has been set up for conveying an appropriate message NAR concerning the re-accessibility of the other mobile radio device MO1 to the second mobile radio device MO2 in the form, for example, of a voice or text message, such as an SMS, upon registration of the first mobile radio device's MO1 having logged on to the mobile network again.

Upon reentry into the mobile network's FUN transmission/reception area BER, a check can be performed by the subscriber administration facility ZTV to determine whether another subscriber's telephone number has been stored in the subscriber administration facility's ZTV storage area assigned to the second mobile radio device MO2. If that is the case, the message NAR can be generated and delivered to the mobile radio device to which the telephone number has been assigned.

Although the present invention has been described with reference to specific embodiments, those of skill in the art will recognize that changes may be made thereto without departing from the spirit and scope of the present invention as set forth in the hereafter appended claims.

1. Method for notifying a first subscriber (TE1) in a mobile network (FUN) about the reentry into said mobile network's (FUN) reception/transmission area (BER) of a second subscriber (TE2) disconnected owing to having left said mobile network's (FUN) transmission/reception area (BER) while a call was in progress between both subscribers (TE1, TE2), with each subscriber (TE1, TE2) being assigned a mobile radio device (MO1, MO2) each having at least one telephone number (RU1, RU2) in said mobile network (FUN) characterized in that the telephone number (RU1) of the first subscriber's (TE1) mobile radio device (MO1) is stored by the mobile network (FUN) when the second subscriber's (TE2) mobile radio device (MO2) leaves the mobile network's (FUN) transmission/reception area (BER) and is used to convey a message (NAR) concerning the reentry of the second subscriber's (TE2) mobile radio device (MO2) into said mobile network (FUN) to the first subscriber's (TE1) mobile radio device (MO1) when the second subscriber's (TE2) mobile radio device (MO2) reenters said mobile network's (FUN) transmission/reception area (BER).

2. Method according to claim 1 characterized in that the telephone number (RU1) of the first subscriber's (TE1) mobile radio device (MO1) is stored in a subscriber administration facility (ZTV) of the mobile network (FUN).

3. Method according to claim 1 or 2 characterized in that the mobile network is a GSM network.

4. Method according to claim 1 or 2 characterized in that the mobile network is a UMTS network.

5. Method according to claim 3 or 4 characterized in that the subscriber administration facility is a Home Location Registry.

6. Telecommunication system (SYS) with a mobile network (FUN) and at least two mobile radio devices (MO1, MO2) to each of which at least one telephone number (RU1, RU2) is assigned in said mobile network (FUN) characterized in that said telecommunication system (SYS) has been set up for storing the first mobile radio device's (MO1) telephone number (RU1) when a second mobile radio device (MO2) leaves the mobile network's (FUN) transmission/reception area (BER) while a call is in progress with a first mobile radio device (MO1), and for conveying a message (NAR) concerning the reentry of said second mobile radio device (MO2) into said mobile network (FUN) to the first mobile radio device (MO1) when the second mobile radio device (MO2) reenters said mobile network's (FUN) transmission/reception area (BER).

7. Telecommunication system according to claim 6 characterized in that a subscriber administration facility (ZTV) is provided for the mobile network (FUN), said facility having been set up for storing the first mobile radio device's (MO1) telephone number (RU1).

8. Telecommunication system according to claim 6 or 7 characterized in that the mobile network is a GSM network.

9. Telecommunication system according to claim 6 or 7 characterized in that the mobile network is a UMTS network.

10. Telecommunication system according to claim 8 or 9 characterized in that the subscriber administration facility (ZTV) is a Home Location Registry.
